(19) United States
(12) Patent Application Publication
(10) Pub. No.: US 2023/0321730 A1
(43) Pub. Date: Oct. 12, 2023

(54) NON-UNIFORM ELECTRIC FIELDS TO COMPACT METAL POWDER BUILD MATERIAL

(71) Applicant: Hewlett-Packard Development Company, L.P, Spring, TX (US)

(72) Inventor: Seongsik Chang, Palo Alto, CA (US)

(73) Assignee: Hewlett-Packard Development Company, L.P, Spring, TX (US)

(21) Appl. No.: 18/022,093

(22) PCT Filed: Aug. 18, 2020
(86) PCT No.: PCT/US2020/046749

§ 371 Date: Feb. 17, 2023

(51) Int. Cl. B22F 12/60; B22F 12/49; B22F 12/90

(52) U.S. Cl. CPC B22F 12/60; B22F 12/49; B22F 12/90; B22F 2202/06

(57) ABSTRACT

In one example in accordance with the present disclosure, an additive manufacturing system is described. The additive manufacturing system includes a build material distributor to deposit metal powder build material on abed. The additive manufacturing system also includes at least a first electrode below the bed and a second electrode above the bed to generate a non-uniform electric field to compact deposited the metal powder build material. A hardening system of the additive manufacturing system selectively hardens metal powder build material in a pattern of a layer of a three-dimensional object to be printed.

### BACKGROUND

Additive manufacturing systems produce three-dimensional (3D) objects by building up layers of material. Some additive manufacturing systems are referred to as “3D printing devices” and use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system for compacting metal powder build material by generating a non-uniform electric field, according to an example of the principles described herein.

FIG. 2 is an isometric view of an additive manufacturing system for compacting metal powder build material by generating a non-uniform electric field, according to an example of the principles described herein.

FIGS. 3A and 3B depict electric fields and an induced dipole in a metal powder build material particle, according to an example of the principles described herein.

FIGS. 4A and 4B depict alternating current electric fields and an induced dipole in a metal powder build material particle, according to an example of the principles described herein.

FIG. 5 is a cross-sectional view of an additive manufacturing system for compacting metal powder build material by generating a non-uniform electric field, according to an example of the principles described herein.

FIGS. 6A and 6B are cross-sectional views of an additive manufacturing system for compacting metal powder build material by generating a non-uniform electric field, according to an example of the principles described herein.

FIGS. 7A and 7B are cross-sectional views of an additive manufacturing system for compacting metal powder build material by generating a non-uniform electric field, according to an example of the principles described herein.

FIGS. 8A-8E are views of an additive manufacturing system for compacting metal powder build material by generating a non-uniform electric field, according to an example of the principles described herein.

FIG. 9 is a flow chart of a method for compacting metal powder build material by generating a non-uniform electric field, according to an example of the principles described herein.

FIG. 10 depicts a non-transitory machine-readable storage medium for compacting metal powder build material by generating a non-uniform electric field, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of build material. Additive manufacturing systems make objects based on data in a 3D model of the object generated, for example, with a computer-aided drafting (CAD) computer program product. The model data is processed into slices, each slice defining portions of a layer of build material that are to be solidified.

In one particular example, a metal powder build material is deposited and a binding agent is selectively applied to the layer of metal powder build material. The binding agent is deposited in a pattern of a slice of a 3D object to be printed. This process is repeated per layer until the 3D object is formed.

With a 3D object formed, the binding agent is cured to form a “green” 3D object. Cured binding agent holds the build material of the green object together. The binding agent may include binding component particles which are dispersed throughout a liquid vehicle. The binding component particles of the binding agent move into the vacant spaces between the metal powder build material particles. The binding component particles in the binding agent are activated or cured by heating the binding agent to about the melting point of the binding component particles. When activated or cured, the binding component particles glue the metal powder build material particles into the cured green object shape. The cured green object has enough mechanical strength such that it is able to withstand extraction from the build material platform without being deleteriously affected (e.g., the shape is not lost). This process is repeated in a layer-wise fashion to generate a green 3D object.

The green 3D object may then be placed in an oven to expose the green 3D object to electromagnetic radiation and/or heat to sinter the build material in the green 3D object to form the finished 3D object. Specifically, the binding agent is removed and the temperature is further raised such that sintering of the powder metal particles occurs to form a metal 3D object. It is to be understood that the term “green” does not connote color, but rather indicates that the part is not yet fully processed.

In another example, referred to as selective laser melting (SLM), portions of the metal powder build material are selectively melted to form a slice of a 3D printed object. In SLM, no binding agent is used and no subsequent oven-sintering process is performed. That is, in this case, the metal 3D object is formed as a high power-density laser melts and fuses metallic powder particles together. Similar to binding-agent based systems, the SLM additive operation may be performed in a layer-wise fashion where a layer of metal powder build material is laid down and select portions are fused. The process is repeated until a complete metal 3D object is formed.

As yet another example, referred to as electron-beam melting (EBM), the powder build material is placed under vacuum and fused together from heat energy from an electron beam. Similar to binding-agent based systems and selective laser melting, in EBM the 3D object to be formed is built in a layer-by-layer fashion. The principles described herein, apply to any of the aforementioned metal powder additive manufacturing systems as well as other metal additive manufacturing systems that form a metal part using metal powder build material.

While such additive manufacturing operations have greatly expanded manufacturing and development possibilities, further development may make 3D printing a part of even more industries. For example, in metal 3D printing, having a high-density powder spread may result in higher quality parts with greater mechanical strength and more uniform dimensional properties.

In general, two forces determine the quality of the powder spread. First is the weight of the particle, and second is the Van der Waals forces, or short-range electrostatic attractive forces, between particles. If Van der Waals forces are greater than the weight of the metal build material particles, the metal build material particles may aggregate together. This may hinder uniform spread of the metal powder build material and may result in a reduced spread density as build material particles may not fall into lower available space. That is, the Van der Waals forces result in air pockets dispersed throughout a layer of metal powder build material. In some examples, the particles may fill the air gaps as the metal powder melts to form the 3D printed object. However, in other examples, the metal build material particles may not melt, but may bond together and may not fill in the gaps. In some examples, metal particles are big enough and weigh enough to overcome the Van der Waals forces. However, other metal particles, such as those used in binder jet printing may be on the order of 5-15 micrometers in diameter and the Van der Waals forces may interfere with spread and high-density packing. As described above, such air voids may result in voids in the complete 3D object which may result in reduced part strength and dimensional accuracy among other object defects.

Accordingly, the present specification describes a compacting of the metal powder build material prior to hardening. Doing so may result in a more uniform spread and a higher packing density. Specifically, the present specification draws metal powder build material particles down to fill any available spaces and increases packing density. Specifically, the present specification applies a non-uniform electric field across the layer of metal powder build material to generate an induced dipole within each metal powder build material particle. A dipole refers to a pair of positive and negative charges separated at a distance. Specifically, in this case, a concentration of positive electric charge is separated from a concentration of negative charge within a metal build material particle. That is, while each metal build material particle may have a neutral charge, positively-charged particles and negatively-charged particles within the metal build material particle are free to move about.

For example, metal build material particles may not have a charge. Accordingly, the total electrostatic force, F, under a uniform electric field, E, may be zero. However, the electric field may induce a dipole within each metal powder build material particle. If the electric field value is different at the positive end of the dipole and the negative end of the dipole, there may be a net directional force on the metal powder build material particle. This net force may be generated such that it is a downward force, drawing the metal powder build material particle down to fill air voids.

Specifically, the present specification describes an additive manufacturing system. The additive manufacturing system includes a build material distributor to deposit metal powder build material on a bed. The additive manufacturing system also includes at least a first electrode below the bed and a second electrode above the bed to generate a non-uniform electric field to compact deposited metal powder build material. A hardening system of the additive manufacturing system selectively hardens metal powder build material in a pattern of a layer of a three-dimensional (3D) object to be printed.

The present specification also describes a method of compacting build material. According to the method, a layer of metal powder build material is deposited on a bed. A non-uniform electric field is generated between a first electrode underneath the bed and a second electrode above the bed to generate an induced dipole in the metal powder build material particles. An electrode is scanned across the bed to move the non-uniform electric field and to compact the metal powder build material.

The present specification also describes a non-transitory machine-readable storage medium encoded with instructions executable by a processor. The instructions are executable by the processor to 1) deposit a layer of metal powder build material on a bed, 2) apply a voltage between a first electrode underneath the bed and a second electrode above the bed to generate a non-uniform electric field across a bed with metal powder build material deposited thereon to draw down the metal powder build material, and 3) selectively harden portions of the metal powder build material in a pattern of a layer of a three-dimensional (3D) object to be printed.

Such systems and methods 1) provide fora uniform powder spread; 2) increase build material packing density; 3) implements electric operation rather than mechanical operation resulting in fewer moving parts and less likely mechanical breakdown; and 4) may result in quicker powder material compaction.

As used in the present specification and in the appended claims, the term “selectively harden” and “hardening system” refer to any fusing, binding, melting, or sintering of raw metal powder build material into a solid portion of a 3D object.

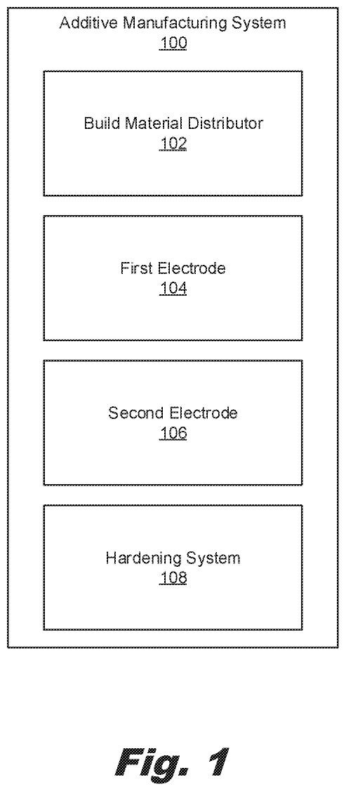

Turning now to the figures, FIG. 1 is a block diagram of an additive manufacturing system (100) for compacting metal powder build material by generating a non-uniform electric field, according to an example of the principles described herein. In one example, the additive manufacturing system (100) of the current specification provides 3D objects with increased mechanical strength and dimensional accuracy. The additive manufacturing system (100) provides such a 3D object by generating a non-uniform electric field and induced dipole in the metal build material particles before they are hardened together to form part of the 3D object. The non-uniform electric field and induced dipole draw the metal build material particles downward to fill air gaps and increase the packing density of the build material. Note that while the present specification describes a binding agent-based additive manufacturing system, the additive manufacturing system (100) may be of other types, including the aforementioned selective laser melting (SLM) and electron beam melting (EBM) additive manufacturing processes.

The additive manufacturing system (100) may include a build material distributor (102) to deposit metal powder build material on a bed. This metal powder build material may be the raw material from which a 3D object is formed. That is, portions of the metal powder build material that are joined together form a solid metal structure. The metal powder build material may be of a variety of types. For example, the metal powder build material may include metallic particles such as steel, bronze, titanium, aluminum, nickel, cobalt, iron, nickel cobalt, gold, silver, platinum, copper and alloys of the aforementioned metals. While several example metals are mentioned, other alloy build materials may be used in accordance with the principles discussed herein.

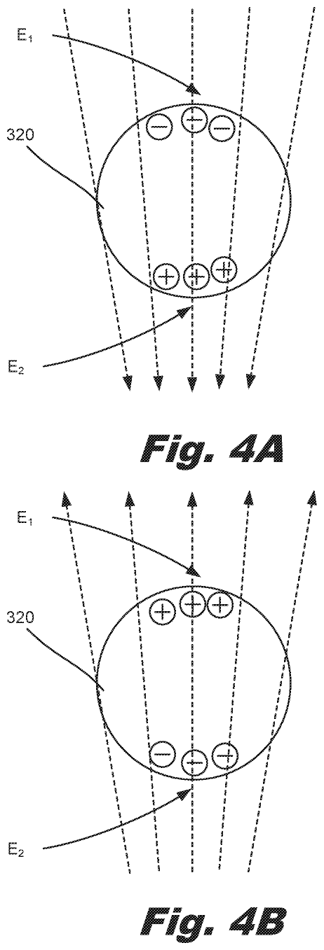

The additive manufacturing system (100) may also include at least a first electrode (104) which is below the bed and a second electrode (106) which is above the bed. These two electrodes (104, 106) are used to generate a non-uniform electric field to compact deposited metal powder build material. In general, the electrode geometry is shaped so that electric field is not uniform and has different strengths at the positive charge location of the dipole and at the negative charge location of the dipole. The force exerted in the positive charge and that in the negative charge will be different, and therefore there will be a net force in the dipole of the metal powder build material particle. This force draws the build material particles downward when the electric field is stronger toward the bottom. FIGS. 4A-8E below depict various examples of electrode structures that result in a non-uniform, dipole-inducing electric field.

The additive manufacturing system (100) also includes a hardening system (108) to selective harden metal powder build material in a pattern of a layer of a 3D object to be printed. That is, as described above, once the metal build material is deposited, the hardening system (108) solidifies portions of the metal powder build material.

In the example of a binding agent-based system, a binding agent is deposited on the build material in a pattern of a slice of a 3D object to be printed. Accordingly, in one example the hardening system (108) includes an agent distribution system to selectively deposit a binding agent on the metal powder build material in a pattern of a layer of a 3D object to be printed. This process is repeated in a layer-wise fashion to generate the green 3D object which is then moved to a sintering furnace.

In other examples, such as with SLM or EBM, the hardening system (108) includes a laser or electron beam that fuses the metal powder build material in a particular pattern, without reliance on a binding agent to be deposited thereon.

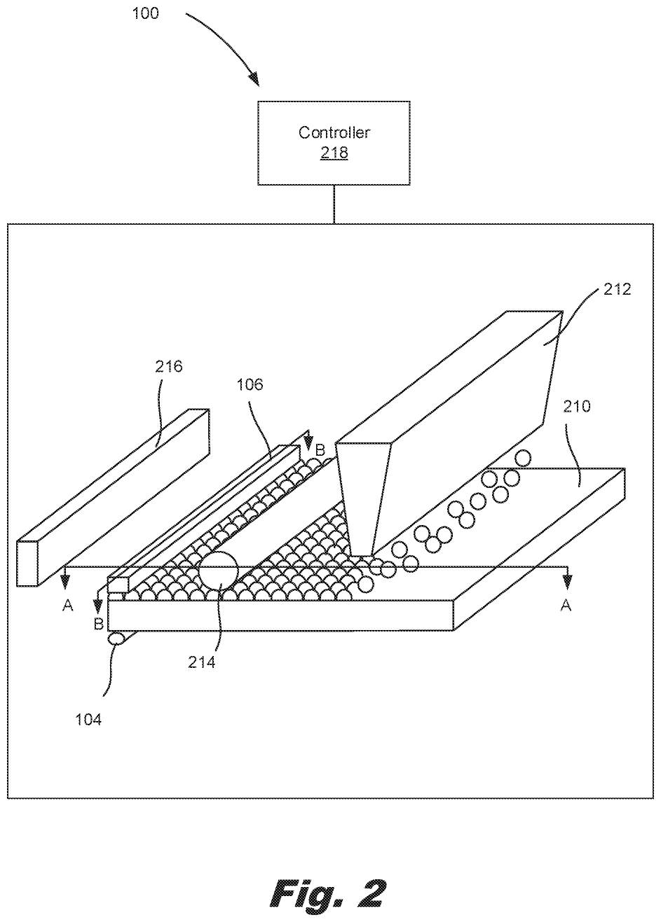

FIG. 2 is an isometric view of an additive manufacturing system (100) for compacting metal powder build material by generating a non-uniform electric field, according to an example of the principles described herein. Components of the additive manufacturing system (100) depicted in FIG. 2 may not be drawn to scale and thus, the additive manufacturing system (100) may have a different size and/or configuration other than as shown therein.

In an example of an additive manufacturing process, a layer of build material may be deposited onto a bed (210). That is, a build material distributor (FIG. 1, 102) may include a dispenser (212) that drops metal powder build material onto the bed (210). The build material distributor (FIG. 1, 102) may also include a roller (214) or other mechanism to smooth the deposited metal powder build material. While FIG. 2 depicts a roller (214), other examples of a mechanism to smooth the deposited metal powder build material may include a blade or ultrasonic blade.

FIG. 2 also clearly depicts an example hardening system (FIG. 1, 108). Specifically, FIG. 2 depicts a binding-agent based additive manufacturing system (FIG. 1, 100), where the hardening system (FIG. 1, 108) includes an agent distribution system (216) to deposit a binding agent onto the metal powder build material. However, in other examples, the hardening system (FIG. 1, 108) may include a laser such as in an SLM additive manufacturing system or an electron beam such as in an EBM additive manufacturing system.

In some examples, these components, i.e., the dispenser (212), roller (214), and agent distribution system (216) may be coupled to scanning carriages. During additive manufacturing, these components operate as the scanning carriages to which they are coupled move over the bed (210) along the scanning axis.

In some examples, the electrodes (104, 106) move as well. That is, the first electrode (104) and the second electrode (106) may scan across a length of the bed (210), the length being defined in FIG. 2 in the left-to-right direction. Accordingly, the first electrode (104) and the second electrode (106) may also be disposed on scanning carriages that traverse over the bed (210). The second electrode (106) may be coupled to the build material distributor carriage, the agent distribution system carriage or, as depicted in FIG. 2, a carriage independent of the build material distributor carriage and the agent distribution system carriage. In this example, the non-uniform electric field generated by the electrodes (104, 106) is moved by moving at least one electrode.

In some examples, the bed (210) may be moved up and down, e.g., along the z-axis, so that metal powder build material may be delivered to the bed (210) or to a previously formed layer of powder build material. For each subsequent layer of metal powder build material to be delivered, the bed (210) may be lowered so that the dispenser (212) and roller (214) can operate to place the metal powder build material particles onto the bed (210). Note that in this example, the first electrode (104) which is beneath the bed (210) may be couple to the bed (210). Accordingly, the controller (218) may lower the bed (210) and the first electrode (104) following formation of a layer of the 3D object to be printed.

Each of the previously described physical elements may be operatively connected to the controller (218) which controls the additive manufacturing. Specifically, in a binding agent-based system, the controller (218) may direct a build material distributor (FIG. 1, 102) and any associated scanning carriages to move to add a layer of metal powder build material. The controller (218) may also, via a voltage difference between the electrodes (104, 106), generate the non-uniform electric field and control any associated carriages to move the non-uniform electric field.

Further, the controller (218) may send instructions to direct a printhead of an agent distribution system (216) to selectively deposit the agent(s) onto the surface of a layer of the build material. The controller (218) may also direct the printhead to eject the agent(s) at specific locations to form a 3D printed object slice. In the example, where the hardening system (FIG. 1, 108) includes an agent-less component such as a laser or electron beam, the controller (218) may direct operation of those components.

The controller (218) may include various hardware components, which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (218) cause the controller (218) to implement at least the functionality of building a 3D printed object.

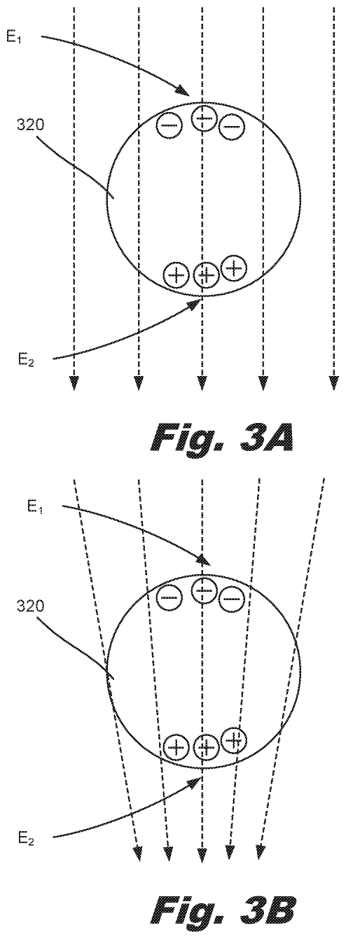

FIGS. 3A and 3B depict electric fields and an induced dipole in a metal powder build material particle (320), according to an example of the principles described herein. Specifically, FIG. 3A depicts a dipole in a metal build material particle (320) in a uniform electric field and FIG. 3B depicts a dipole in a metal build material particle (320) in a non-uniform electric field. Note that in both examples, the net charge, q, on the metal build material particle (320) is zero. However, in the presence of an electric field, charged elements are free to move about within the metal build material particle (320). That is, with a uniform electric field as depicted in FIG. 3A, an electric field at the top of the metal build material particle (320) may have a first value, E₁, which matches the electric field at the bottom of the metal build material particle (320), E₂, such that the overall electrostatic force, F_{E}, on the metal build material particle (320) is 0. That is, F_{E}=q(E₁−E₂) results in F_{E}=0. However, in a non-uniform electric field such as that depicted in FIG. 3B, the electric field at the top of the metal build material particle (320) may have a first value, E₁, which is different than the electric field at the bottom of the metal build material particle (320), E₂, such that there is an overall net force on the metal build material particle (320). That is, F_{E}=q(E₂−E₁) does not result in F_{E}=0. Such a non-uniform electrical field is generated by applying a voltage between the first and second electrodes (FIG. 1, 104, FIG. 1, 106).

FIGS. 4A and 4B depict alternating current electric fields and an induced dipole in a metal powder build particle (320), according to an example of the principles described herein. That is, in this example an alternating current (AC) voltage is applied between the first electrode (FIG. 1, 104) and the second electrode (FIG. 1, 106). In this example, the electrostatic force may be applied in a periodic fashion with zero force applied in between periods of a non-zero electrostatic force. Such a zero force allows the metal build material particle (320) to settle. This may allow for the relaxation and rearrangement of the metal build material particles (320) in the bed (FIG. 2, 210). Within an AC cycle of the voltage, even though an electric field direction changes as the polarity of AC voltage changes, the polarization of the induced dipole changes as well. Accordingly, the net force direction does not change.

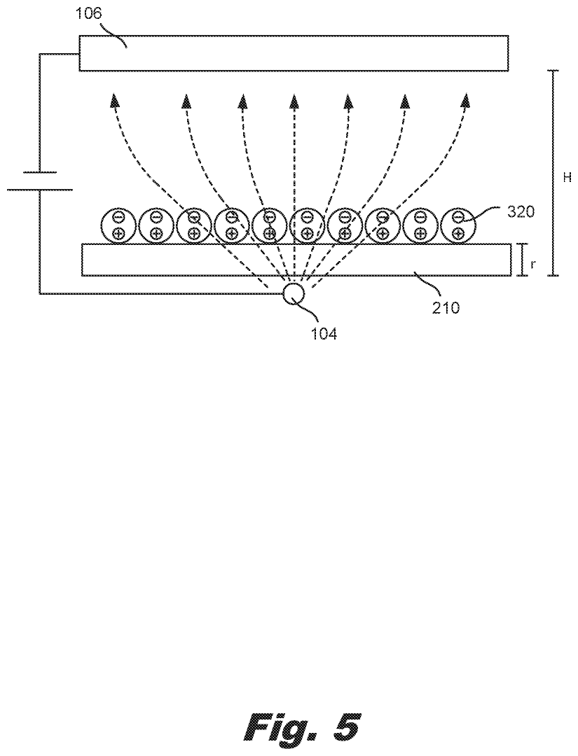

FIG. 5 is a cross-sectional view of an additive manufacturing system (100) for compacting metal powder build material by generating a non-uniform electric field, according to an example of the principles described herein. Specifically, FIG. 5 is a cross-sectional view taken along the line A-A in FIG. 2.

To create the non-uniform electric field, the first electrode (104) may be sized differently than the second electrode (106). Specifically, in the example depicted in FIG. 5, the first electrode (104) is an electrical wire that extends a width of the bed (FIG. 2, 210) and the second electrode (106) is a plate electrode. In this example, the first electrode (104) is situated at a distance, r, from the first powder layer and the second electrode (106) is situated at a distance, H, from the first powder layer. As shown in FIG. 5, a non-uniform electric field results from this electrode (104, 106) structure and a dipole is formed within each metal build material particle (320). The electric field is stronger near the bottom of the powder. Accordingly, the net force on the metal build material particles (320) is downward, which reduces unintended voids in the 3D printed object, thus increasing part uniformity, density, and overall strength.

As a specific example, the electric field, E, at an individual metal build material particle (320) may be estimated by the electric field by an infinitely long cylinder as indicated in Equation (1):

$$E ( r ) = \frac{σ}{2 {πε}_{0} r} . \qquad Eq . ( 1 )$$

In Equation (1), σ is a line charge density, r is a distance from the electrical wire, and ε₀ is the electrical permittivity in vacuum. Given boundary conditions of V=V₀ at the first electrode (104) and V=0 at the second electrode (106), a voltage of the electric field may be estimated as,

$$V ( r ) = \frac{σ}{2 {πε}_{0}} ln \frac{H}{r} . \qquad Eq . ( 2 )$$

In Equation (2), by using the above noted voltage boundary conditions, line charge density, σ can be expressed as

$$σ = 2 {πε}_{0} \frac{{V}_{0}}{ln \frac{H}{{R}_{w}}} , \qquad Eq . ( 3 )$$

where R_{w} is the radius of the electrical wire

The force on a metal build material particle (320) be estimated by

$${F}_{E} = {q}_{ind} ( {E}_{1} - {E}_{2} ) = {q}_{ind} ( \frac{σ}{2 {πε}_{0} {r}_{1}} - \frac{σ}{2 {πε}_{0} {r}_{2}} ) = {q}_{ind} ( \frac{σ \cdot d}{2 {πε}_{0} {R}^{2}} ) , \qquad Eq . ( 4 )$$

where subscript 1 and 2 indicate the position of charges within the metal build material particle (320) and d is the diameter of a build material particle (320). Induced charge, q_{ind}, can be calculated given that induced charges at the metal build material particle (320) is at a similar level of line charge density σ at the wire, i.e., q_{ind}˜σ·d. Then, the force on the build material particle (320) is:

$${F}_{E} = \frac{{( σ \cdot d )}^{2}}{2 {πε}_{0} {R}^{2}} = 2 {πε}_{0} {V}_{0}^{2} \frac{{d}^{2}}{{R}^{2} ln ( \frac{H}{{R}_{w}} )} . \qquad Eq . ( 5 )$$

A weight of a 10 micrometer (μm) diameter stainless-steel build material particle (320) may be 3.2×10⁻⁸ Newtons (N). Accordingly, it may be desirable for the electrostatic force, F_{E}, on the metal build material particle (320) to be greater than its weight. Given the above equations, such a force, F_{E}, may result when the V₀ is 5 kilovolts (kV), r is less than 1 millimeter (mm), H is less than 1 centimeter (cm), and a radius of the electrical wire, R_{w}, is 100 μm. The strongest electric field in this geometry will be adjacent the first electrode (104) and may have an intensity of 0.5V/um, which is six times lower than the voltage at which arcing may occur. Thus, it is safe to operate.

Note that in this example, both the first electrode (104) and the second electrode (106) may scan across a length of the bed, which in the orientation depicted in FIG. 2, is left-to-right.

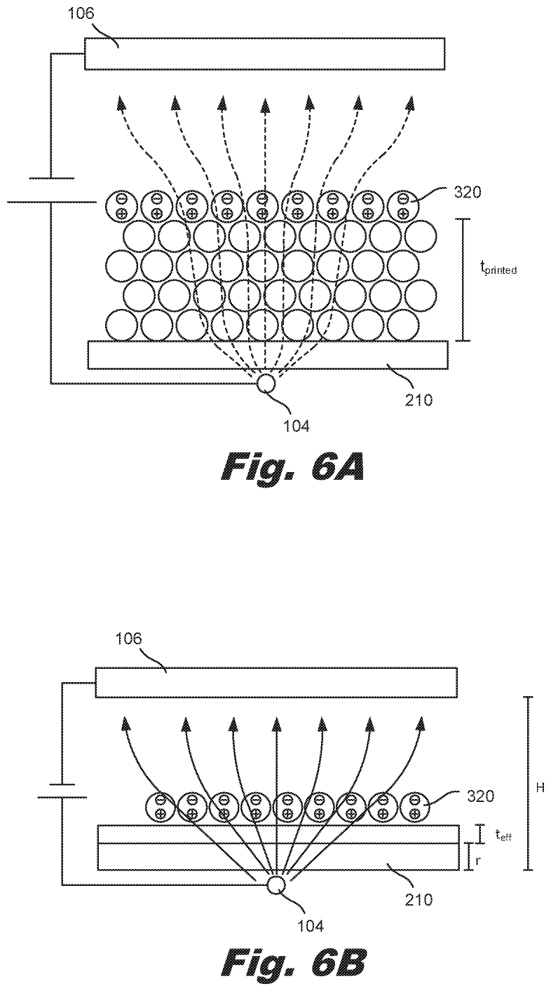

FIGS. 6A and 6B are cross-sectional views of an additive manufacturing system (100) for compacting metal powder build material by generating a non-uniform electric field, according to an example of the principles described herein. Specifically, FIGS. 6A and 6B are cross-sectional views taken along the line A-A in FIG. 2. More specifically, FIGS. 6A and 6B depict the non-uniform electric field after additional layers of build material have been deposited. That is, as the layers are formed, the distance between the first electrode (104) and the second electrode (106) increases on account of the first electrode (104) moving downward along with the bed (210) to accommodate additional layers of build material. Note that in these examples, the underlying layers are a combination of metal and air. For purposes of determining the electrostatic force, F_{E}, on an individual particle (320) being laid down, the thickness of the printed layers, t_{printed}, as depicted in FIG. 6A may be converted to an effective thickness, t_{eff}. That is, in the underlying printed layers, the dielectric constant of the metal is infinite, such that metal mixed with air may be represented as the dielectric constant of air with a thickness of t_{eff}. Put another way, for the underlying printed layers, a portion may be fused metal and/or unfused metal powder. These underlying layers which are a mixture of metal and air may have an effective air thickness, t_{eff}, expressed as:

t_{eff}=(1−d_{pack})·t_{printed} Eq. (6)

In Equation 6, t_{printed} is the thickness of the printed object and d_{pack} is the packing density. Therefore, the underlying layers may be treated as a dielectric (air) layer with a thickness of t_{eff}. Accordingly, the net electrostatic force, F_{E}, on the metal build material particle (320) may be estimated as:

$${F}_{E} = 2 {πε}_{0} {V}_{0}^{2} \frac{{d}^{2}}{{( R + {t}_{eff} )}^{2} ln ( \frac{H}{{R}_{W}} )} . \qquad Eq . ( 7 )$$

Accordingly, the electrostatic force, F_{E}, on an individual metal build material particle (320) may be reduced by:

(R/(R+t_{eff}))^{2 Eq. (}8).

To accommodate for the reduced electrostatic force, F_{E}, the voltage applied at the electric wire may be increased to provide an electrostatic force that is greater than the weight of the metal build material particle (320) while remaining under the voltage at which arcing occurs.

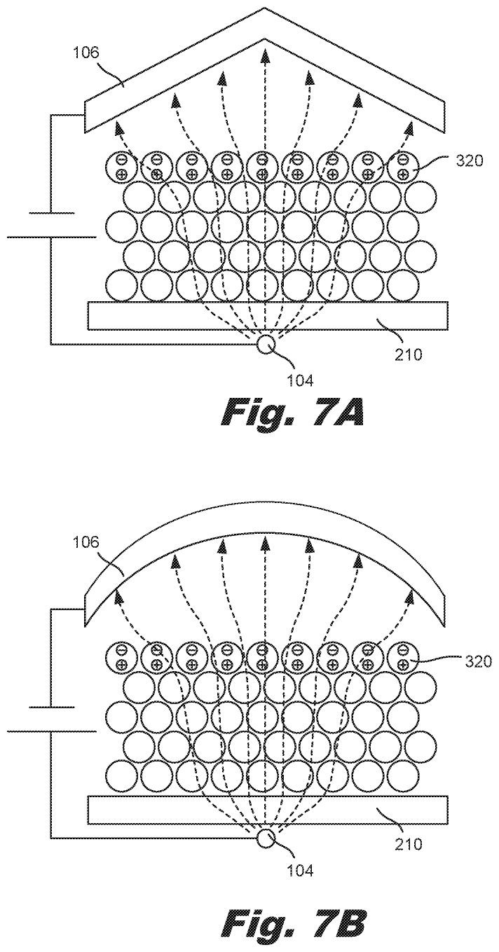

FIGS. 7A and 7B are cross-sectional views of an additive manufacturing system (100) for compacting metal powder build material by generating a non-uniform electric field, according to an example of the principles described herein. Specifically, FIGS. 7A and 7B are cross-sectional views taken along the line A-A in FIG. 2. In the example depicted in FIG. 7A, the second electrode (106) is an angled plate electrode and in the example depicted in FIG. 7B, the second electrode (106) is a curved plate electrode. The angled plate and curved plate second electrodes (106) may result in even a greater disparity between the electric field at the top and bottom of the build material particles (320). This may be because the electric field direction is normal to a metal surface of the second electrode (106). The greater disparity may result in a greater net force downward on the metal build material particles (320).

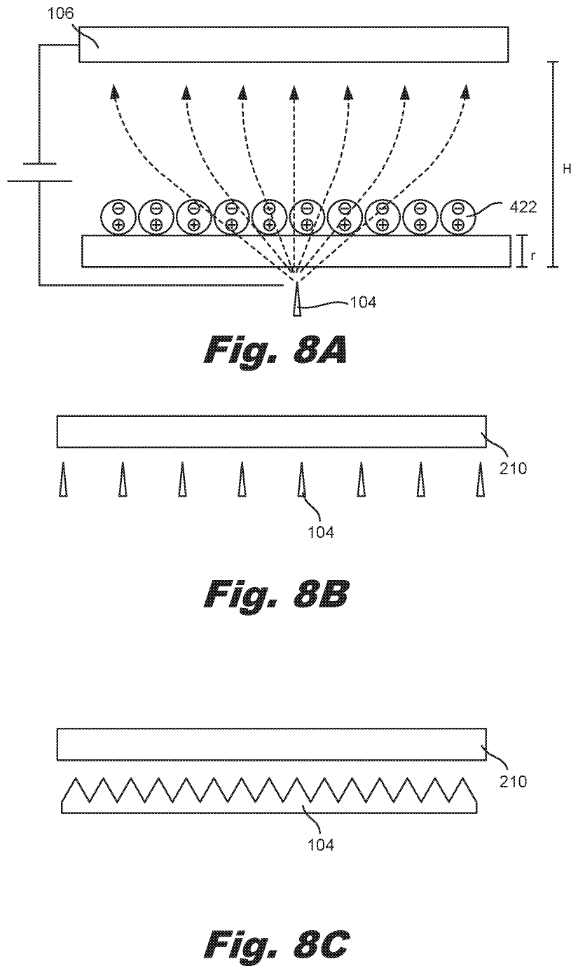

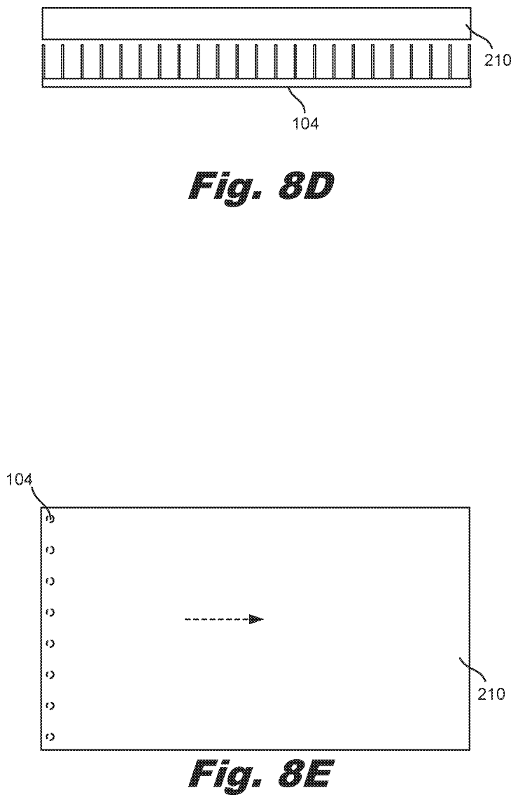

FIGS. 8A-8E are views of an additive manufacturing system (100) for compacting metal powder build material by generating a non-uniform electric field, according to an example of the principles described herein. Specifically, FIG. 8A is a cross-sectional view taken along the line A-A in FIG. 2, FIGS. 8B-8D are cross-sectional views taken along the line B-B in FIG. 2, and FIG. 8E is a top view in which the first electrode (104) translates underneath the bed (210) as indicated by the arrow. Note that in FIG. 8E, the first electrode (104) is indicated in dashed-lines to indicate a position underneath the bed (210).

In the example depicted in FIGS. 8A, 8B, and 8E, the first electrode (104) is a series of point electrodes. That is, the point electrodes may extend across a width (up and down in FIG. 2) of the bed and may translate across a length of the bed as indicated by the arrow in FIG. 8E.

The electrical wire depicted in FIGS. 5-7B may have an electric field that varies 1/r. By comparison, the electric field around a point charge in spherical symmetry varies 1/r². Therefore, the electrode structure with a point charge first electrode (104) and a flat plate second electrode (106) may have a stronger field gradient. Thus, the strength of the electrostatic force, F_{E}, on the metal powder build material particles (320) would be greater. In an example with a point charge electrode, the electric field near the first layer of powder may be approximated by the electric field for a point charge as indicated in Equation (9).

$$E = \frac{Q}{4 {πε}_{0} {r}^{2}} . \qquad Eq . ( 9 )$$

The voltage with boundary conditions of V(r=H, right above the point charge)=0 and V(r=Rₚ, radius of the point)=V₀ is given by

$$V ( r ) = \frac{Q}{4 {πε}_{0}} ( \frac{1}{H} - \frac{1}{r} ) , \qquad Eq . ( 10 )$$

$$Q = \frac{4 {πε}_{0} {V}_{0}}{\frac{1}{H} - \frac{1}{{R}_{p}}} .$$

In Equation (10), H is the distance between the point electrode and the second electrode (106) and Rₚ is the radius of the curvature of the point electrode. The net electrostatic force, F_{E}, at the first layer of the powder by induced dipole and non-uniform electric field may be estimated as:

$${F}_{E} = {q}_{ind} ( {E}_{1} - {E}_{2} )$$

$${F}_{E} = {q}_{ind} \frac{Q}{4 {πε}_{0}} ( \frac{1}{{r}_{1}^{2}} - \frac{1}{{r}_{2}^{2}} )$$

$${F}_{E} = {q}_{ind} \frac{Q}{4 {πε}_{0}} ( \frac{( {r}_{2} + {r}_{1} ) ( {r}_{2} - {r}_{1} )}{{r}_{1}^{2} {r}_{2}^{2}} )$$

$${F}_{E} \approx {q}_{ind} \frac{Q}{2 {πε}_{0}} \frac{d}{{R}^{3}}$$

Using the induced surface charge density at the powder is similar to the surface charge density at the point

$$\frac{{q}_{ind}}{{d}^{2}} \approx \frac{Q}{{R}_{p}^{2}}$$

The net force on a build material particle (320) may be estimated as:

$${F}_{E} = \frac{{Qd}^{2}}{{R}_{p}^{2}} \frac{Q}{2 {πε}_{0}} \frac{d}{{R}^{3}}$$

$${F}_{E} = {\frac{1}{2 {πε}_{0}} [ \frac{4 {πε}_{0} {V}_{0}}{\frac{1}{H} - \frac{1}{{R}_{p}}} ]}^{2} \frac{{d}^{3}}{{R}_{p}^{2} {R}^{3}}$$

$${F}_{E} \approx 8 {πε}_{0} {V}_{0}^{2} {H}^{2} \frac{{d}^{3}}{{R}_{p}^{2} {R}^{3}}$$

Accordingly, because an electric field varies ˜1/r2 for point electrodes as compared to 1/r for an electrical wire, the electric field gradient is stronger, and therefore a stronger electrostatic force may be exerted on the individual metal build material particles (320).

For example, using the same conditions used for the electrical wire case for a 10 (μm) diameter metal build material particle (320), i.e., R=1 mm, H=1 cm, Rₚ=100 um, and V₀=5 kV, F_{E} is calculated to be 6.3×10⁻⁶, which is 200× higher than the structure with an electrical wire at a similar values of distances, R, H, radius of curvature Rₚ, and voltage V₀.

Note that while various structures have been described, i.e., electrical wire first electrode (104), point first electrode (104), curved second electrode (106), angled second electrode (106), and flat second electrode (106), a variety of combinations of these may be used. For example, a first electrode (104) may include a series of point electrodes while the second electrode (106) is a curved or wedge shaped. Moreover, other structures may be possible as well, such as an array of pyramids as depicted in FIG. 8C as the bottom electrodes and a comb structure as depicted in FIG. 8D.

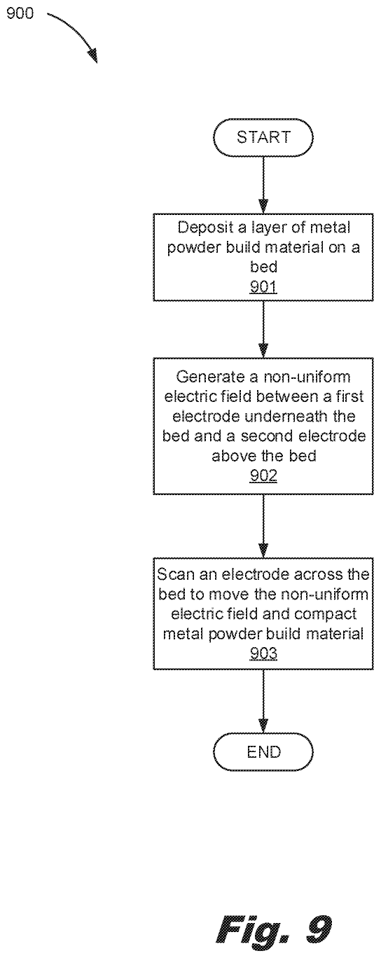

FIG. 9 is a flow chart of a method (900) for compacting metal powder build material by generating a non-uniform electric field, according to an example of the principles described herein. Each of the operations detailed in FIG. 9 may be performed for an individual layer that is to form a 3D object. According to the method (900), a metal powder build material is deposited (block 901) on a surface. The surface may be a bed (FIG. 2, 210) or a previously deposited layer of metal powder build material. For example, under the direction of a controller (FIG. 2, 218), a build material distributor (FIG. 1, 102) may spread the supplied metal powder build material particles onto the bed (FIG. 2, 210).

With metal powder build material spread, the method (900) includes generating (block 902) a non-uniform electric field between a first electrode (FIG. 1, 104) underneath the bed (FIG. 2, 210) and a second electrode (FIG. 1, 106) above the bed (FIG. 2, 210) to generate an induced dipole in the metal powder build material particles (FIG. 4, 422). As described above, the non-uniform electric field may be generated by positioning electrodes of different sizes on top and beneath the bed (FIG. 2, 210) with the stronger electric field being formed near the first electrode (FIG. 1, 104) underneath the bed (FIG. 2, 210) so as to draw down metal powder build material particles (FIG. 3, 320). At least one electrode (FIG. 1, 104, FIG. 1, 106) and in some cases both, are scanned (block 903) across the bed (FIG. 2, 210) to move the non-uniform electric field to compact the metal powder build material. That is, the electrodes (FIG. 1, 104, 106) may be coupled to scanning carriages. As the scanning carriages move, metal build material particles (FIG. 3, 320) that come under the influence of the non-uniform electric field are drawn down to fill air voids that may result from the rough deposition of the build material by the build material distributor (FIG. 1, 102). Thus, the present method (900) generates a denser, and more uniform powder build layer upon which an agent such as a binding agent may be deposited to form a 3D printed object. The 3D printed object, on account of the uniform and dense packing of the build material may have more product uniformity and increased mechanical strength.

Once compacted, portions of the metal powder build material are hardened together to form the 3D object. In the case of a binding agent-based system, a binding or other agent is selectively applied on a portion of the metal powder build material that is to form a layer of a 3D object. Once the entire object is formed, the green 3D object is moved to a sintering furnace where it is hardened.

In the case of an agent-less system, such as an SLM or an EBM additive manufacturing system, a laser, electron beam or other energy source is activated to heat portions of the metal powder build material that is to form the 3D object layer. Specifically, the controller (FIG. 2, 218) may execute instructions to control the hardening system (FIG. 1, 108) to harden portions of the raw build material that is to form the 3D object layer. As an example, if the 3D object that is to be formed is to be shaped like a cube or cylinder, a square pattern or a circular pattern (from a top view) of the metal powder build material may be hardened.

As described above, these operations (blocks 901, 902, 903) may be repeated to iteratively build up multiple patterned layers and to form the 3D object. For example, the controller (FIG. 2, 218) may execute instructions to cause the bed (FIG. 2, 210) to be lowered to enable the next layer of metal powder build material to be spread. In addition, following the lowering of the bed (FIG. 2, 210), the controller (FIG. 2, 218) may control the build material distributor (FIG. 1, 102) to form another layer of metal powder build material particles on top of the previously formed layer. The newly formed layer may be acted upon by the electrodes and the hardening system (FIG. 1, 108) as described above.

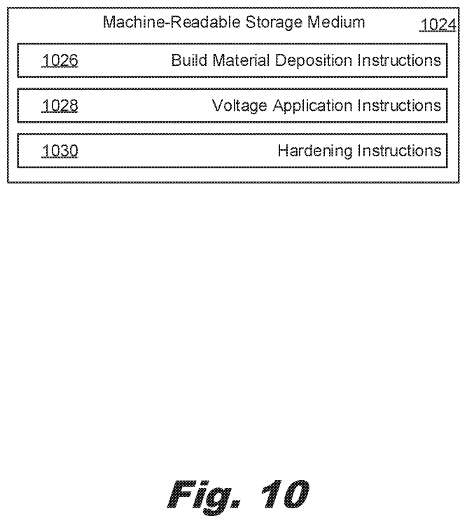

FIG. 10 depicts a non-transitory machine-readable storage medium (1024) for compacting build material by generating a non-uniform electric field, according to an example of the principles described herein. To achieve its desired functionality, a controller (FIG. 2, 218) includes various hardware components. Specifically, a controller (FIG. 2, 218) includes a processor and a machine-readable storage medium (1024). The machine-readable storage medium (1024) is communicatively coupled to the processor. The machine-readable storage medium (1024) includes a number of instructions (1026, 1028, 1030) for performing a designated function. The machine-readable storage medium (1024) causes the processor to execute the designated function of the instructions (1026, 1028, 1030). The machine-readable storage medium (1024) can store data, programs, instructions, or any other machine-readable data that can be utilized to operate the additive manufacturing system (FIG. 1, 100). Machine-readable storage medium (1024) can store computer readable instructions that the processor of the controller (FIG. 2, 218) can process, or execute. The machine-readable storage medium (1024) can be an electronic, magnetic, optical, or other physical storage device that contains or stores executable instructions. Machine-readable storage medium (1024) may be, for example, Random Access Memory (RAM), an Electrically Erasable Programmable Read-Only Memory (EEPROM), a storage device, an optical disc, etc. The machine-readable storage medium (1024) may be a non-transitory machine-readable storage medium (1024).

Referring to FIG. 10, build material deposition instructions (1026), when executed by the processor, cause the processor to deposit a layer of metal powder build material on a bed (FIG. 2, 210). Voltage application instructions (1028), when executed by the processor, may cause the processor to apply a voltage difference between a first electrode (FIG. 1, 104) underneath the bed (FIG. 2, 210) and a second electrode (FIG. 1, 106) above the bed (FIG. 2, 210) to generate a non-uniform electric field across the bed (FIG. 210) to draw down the metal powder build material. Hardening instructions (1030), when executed by the processor, may cause the processor to selectively harden portions of the metal powder build material in a pattern of a layer of a three-dimensional (3D) object to be printed.

Such systems and methods 1) provide fora uniform powder spread; 2) increase build material packing density; 3) implements electrical operation rather than mechanical operation resulting in fewer moving parts and less likely mechanical breakdown; and 4) may result in quicker powder material compaction.

What is claimed is:

1. An additive manufacturing system, comprising:
a build material distributor to deposit metal powder build material on a bed;
at least a first electrode below the bed and a second electrode above the bed to generate a non-uniform electric field to compact deposited metal powder build material; and
a hardening system to selectively harden metal powder build material in a pattern of a layer of a three-dimensional (3D) object to be printed.

2. The additive manufacturing system of claim 1, wherein the first electrode is to scan across a length of the bed.

3. The additive manufacturing system of claim 1, wherein a first electrode is sized differently than the second electrode to generate the non-uniform electric field.

4. The additive manufacturing system of claim 1, wherein the first electrode is an electrical wire.

5. The additive manufacturing system of claim 1, wherein the first electrode is a series of point electrodes.

6. The additive manufacturing system of claim 1, wherein the second electrode is a plate electrode.

7. The additive manufacturing system of claim 6, wherein the second electrode is selected from the group consisting of a curved plate electrode and an angled plate electrode.

8. The additive manufacturing system of claim 1, wherein the second electrode scans across a length of the bed.

9. The additive manufacturing system of claim 8, wherein the second electrode is formed on at least one of:
a build material distributor carriage;
an agent distribution system carriage; and
a carriage independent of the build material distributor carriage and the agent distribution system carriage.

10. The additive manufacturing system of claim 1, wherein an alternating current voltage is applied between the first electrode and the second electrode.

11. The additive manufacturing system of claim 1, wherein the hardening system comprises an agent distribution system to selectively deposit a binding agent on metal powder build material in a pattern of the layer of the 3D object to be printed.

12. A method, comprising:
depositing a layer of metal powder build material on a bed;
generating a non-uniform electric field between a first electrode underneath the bed and a second electrode above the bed to generate an induced dipole in the metal powder build material particles; and
scanning an electrode across the bed to move the non-uniform electric field and compact the metal powder build material.

13. The method of claim 12, wherein the non-uniform electric field is stronger at the first electrode than at the second electrode.

14. A non-transitory machine-readable storage medium encoded with instructions executable by a processor to:
deposit a layer of metal powder build material on a bed;
apply a voltage difference between a first electrode underneath the bed and a second electrode above the bed to generate a non-uniform electric field across a bed with metal powder build material deposited thereon to draw down the metal powder build material;
selectively harden portions of the metal powder build material in a pattern of a layer of a three-dimensional (3D) object to be printed.

15. The non-transitory machine-readable storage medium of claim 13, further comprising instructions executable by the processor to move the non-uniform electric field by moving at least one electrode.
